(19) United States
(12) Patent Application Publication
(10) Pub. No.: US 2026/0031695 A1
(43) Pub. Date: Jan. 29, 2026

(54) BUTTON MOTOR

(71) Applicant: AAC Microtech (Changzhou) Co., Ltd., Changzhou City (CN)

(72) Inventors: Lubin Mao, Changzhou (CN); Wei Song, Changzhou (CN); Tong Zhang, Changzhou (CN); Ze Fu, Changzhou (CN)

(21) Appl. No.: 18/964,659

(22) Filed: Dec. 1, 2024

Related U.S. Application Data
(63) Continuation of application No. PCT/CN2024/107079, filed on Jul. 23, 2024.

(51) Int. Cl. H02K 33/18; H01H 13/14; H02K 11/21

(52) U.S. Cl. CPC H02K 33/18; H01H 13/14; H02K 11/21; H02K 2211/03

(57) ABSTRACT

The present disclosure discloses a button motor a frame, having a receiving space; a stator received in the receiving space, including a magnet unit mounted on the frame; a vibrator moving along a first direction relative to the stator, including: an iron core fixedly connected with the button; and a coil wound on the iron core and arranged opposite to the magnet unit; a button fixed on the vibrator; a FPC mounted on the frame and electrically connected with the coil; a sensor configured to detect the displacement of the vibrator; and an unmetallic elastic member sandwiched between the iron core and the frame, configured to deform along the first direction.

### FIELD OF THE PRESENT DISCLOSURE

The present disclosure relates to touch control button technologies, especially relates to a button motor and an electronic device.

### DESCRIPTION OF RELATED ART

Touch control button realizes the corresponding control by sensing the press signals such as press position and pressure applied by users.

Touch control button generally includes a frame, a motor, a flexible circuit board (FPC) fixed on the motor, a button mounted on the motor, and a sensor fixed on the button. When users press the button, the displacement generated by the motor along the press direction can be detected by the sensor and then recognized for achieving corresponding control.

In related art, the motor includes a magnet serves as stator and a coil served as vibrator. The stator is mounted on the frame. The vibrator is suspended on the frame through an elastic member made of metal and spaced apart from the stator. The metal elastic member has enough structure strength but occupies larger space in the motor, thus resulting in smaller size of the magnet with lower driven force.

Therefore, it is necessary to provide an improved button motor to overcome the problems mentioned above.

### SUMMARY OF THE INVENTION

One object of the present disclosure is to provide a button motor with smaller size elastic member and larger size magnet.

The button motor includes a frame, having a receiving space; a stator received in the receiving space, including a magnet unit mounted on the frame; a vibrator moving along a first direction relative to the stator, including: an iron core fixedly connected with the button; and a coil wound on the iron core and arranged opposite to the magnet unit; a button fixed on the vibrator; a FPC mounted on the frame and electrically connected with the coil; a sensor configured to detect the displacement of the vibrator; and an unmetallic elastic member sandwiched between the iron core and the frame, configured to deform along the first direction.

As an improvement, the unmetallic elastic member is made of silicone or rubber.

As an improvement, further including a connection member integrally-formed with the unmetallic elastic member; the unmetallic elastic member is a blocky structure; the unmetallic elastic member is mounted on the iron core through the connection member.

As an improvement, a groove is provided on the unmetallic elastic member by depressing from a surface of the unmetallic elastic member facing the iron core away from the iron core; the connection member is formed inside the groove.

As an improvement, the stator includes two magnet units respectively arranged on both sides of the coil along a second direction perpendicular with the first direction; each of the two magnet units includes three magnets arranged at intervals and fixed to the frame and magnetized along the second direction; adjacent two of the three magnets are magnetized along opposite direction.

As an improvement, the FPC includes a first support segment located on a side of the iron core away from the button, and a bending segment bended and extended from an end of the first support segment; two ends of the first support segment are fixed on the frame; the first support segment and the iron core are arranged at an interval along the first direction; the bending segment is fixed on the frame; the sensor is mounted on the first support segment and spaced apart from the iron core.

As an improvement, the FPC further includes a second support segment sandwiched between the iron core and the button, and an elastic arm connected with the second support segment and the bending segment; the coil is electrically connected with the second support segment; the elastic arm is opposite to the unmetallic elastic member along the first direction.

As an improvement, a central region of the first support segment is fixed on a side of iron core away from the button through a gasket; the sensor is located on a side of the first support segment towards the iron core and spaced apart from the gasket.

As an improvement, the frame includes two first side walls opposite to each other along the second direction, and two second walls opposite to each other along a third direction; the third direction is perpendicular with the first direction and the second direction; the two magnet units are respectively fixed on the two first side walls; the bending segment is fixed on one of the two second side walls.

The other object of the present disclosure is to provide an electronic device, comprising a cover and the button motor as described above received in the cover; a receiving groove provided on the cover comprises a bottom surface and a through hole penetrating the bottom surface; the frame is mounted on an inner side of the cover; the button is partially received in the receiving groove and fixed on the vibrator through the through hole.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

FIG. 1 is an isometric view of a button motor in accordance with an exemplary embodiment of the present disclosure.

FIG. 2 is an exploded view of the button motor in FIG. 1.

FIG. 3 is a cross-sectional view of the button motor taken along line A-A in FIG. 1.

FIG. 4 is a top view of button motor in FIG. 1.

FIG. 5 is an isometric view of an electronic device including the button motor in FIG. 1.

FIG. 6 is an exploded view of the electronic device in FIG. 5.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

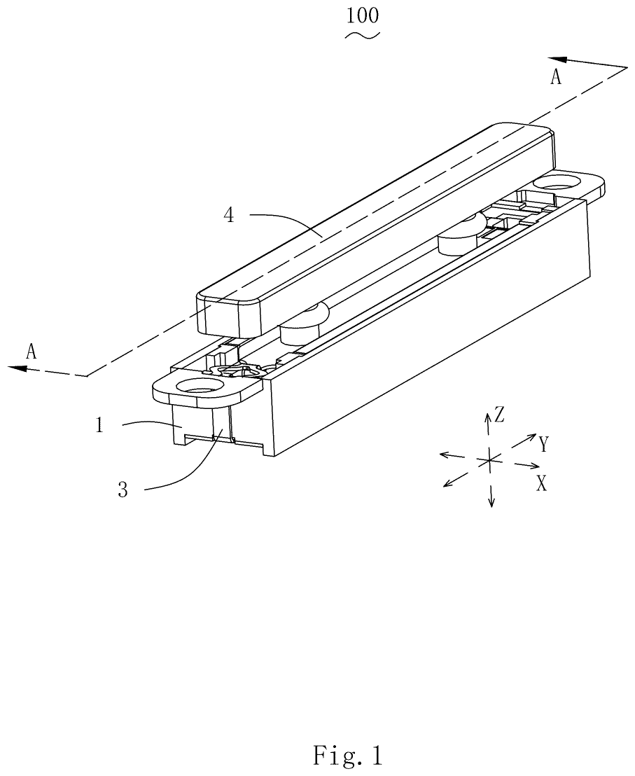

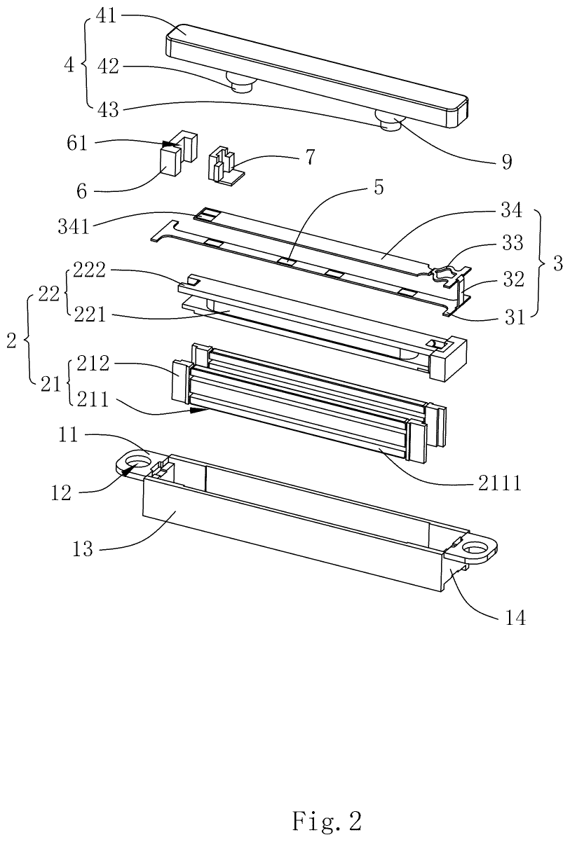

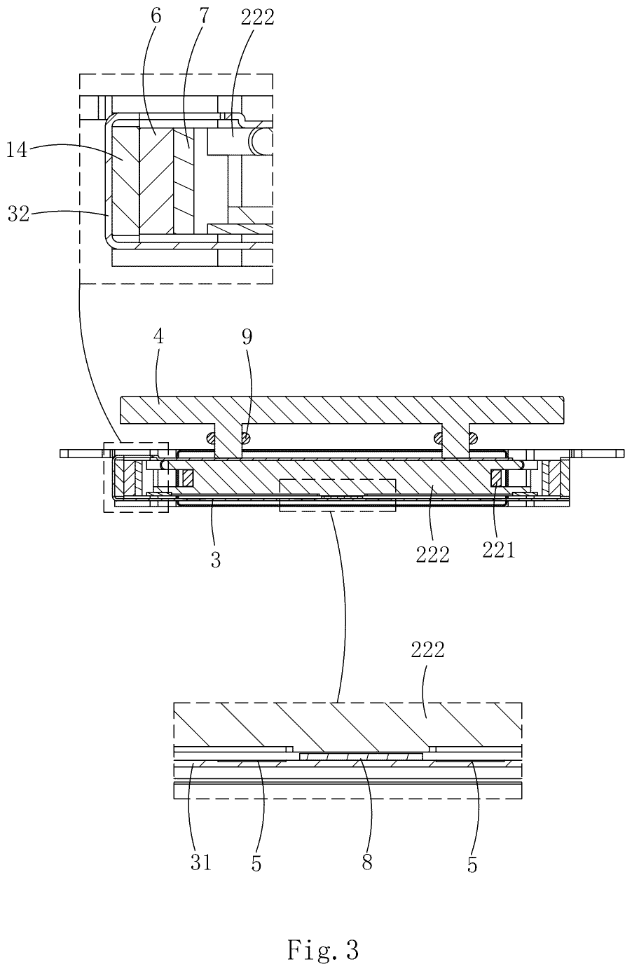

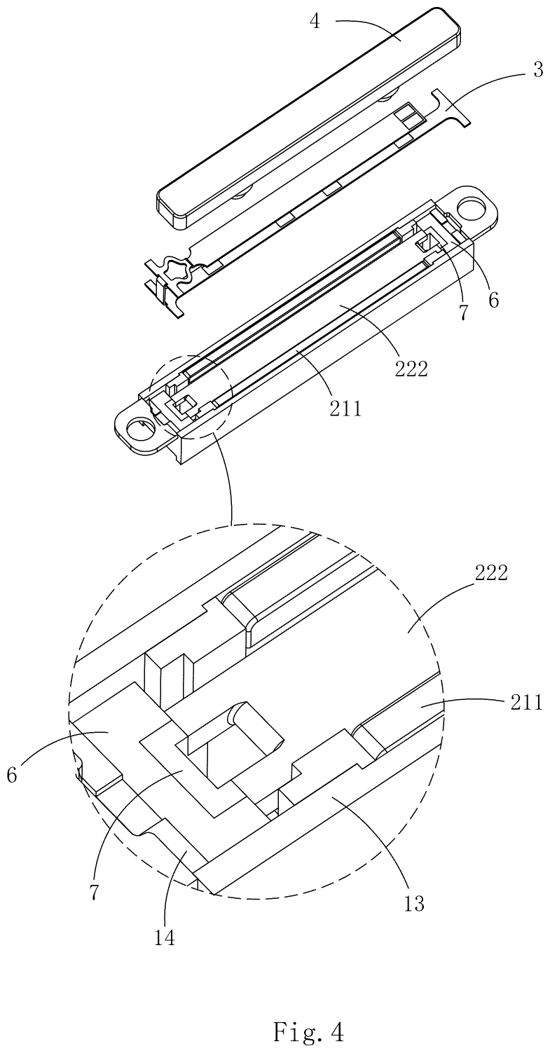

Please refer to FIGS. 1-4 together, a button motor 100 provided by an exemplary embodiment of the present disclosure includes a frame 1 having a receiving space 10, a driven motor 2 received in the receiving space 10. The driven motor 2 includes a stator 21 received in the receiving space 10, and a vibrator 22 moving along a first direction Z relative to the stator 21. The button motor further includes a button 4 fixed on the vibrator 22, a FPC 3 mounted on the frame 10, and a sensor 5 configured to detect the displacement of the vibrator 22. It should be noted that the button 4 moves along the first direction Z when being pressed.

The frame 1 includes two mounting portions 11 extending from two opposite sides. Each of the two mounting portions 11 includes a mounting hole 12 penetrating thereon. The button motor 100 is mounted on other devices through the mounting hole 12 by screw or rivet.

Moreover, the stator 21 includes a magnet unit 211 mounted on the frame 1. The vibrator 22 includes an iron core 222 fixedly connected with the button 4, and a coil 221 wound on the iron core 222 and arranged opposite to the magnet unit 211. The coil 221 is electrically connected with the FPC 3.

In one embodiment, the stator 21 includes two magnet units 211 respectively arranged on both sides of the coil 221 along a second direction X perpendicular with the first direction Z. Each of the two magnet units 211 includes three magnets 2111 arranged at intervals and fixed on the frame 10 and magnetized along the second direction X. Adjacent two of the three magnets 2111 are magnetized along opposite direction. Specifically, the middle one of the three magnets 2111 has opposite magnetization direction with adjacent magnet 2111. In this manner, the driving force of the magnet unit 211 is not affected by its assembly tolerance.

The stator 21 further includes four cover plates 212 fixed on an inner surface of the frame 1. Every two of the four cover plates 212 are located on both sides of each of the two magnet units 211.

The button 4 includes a main body portion 41 opposite to the frame 1, and a first connection portion 42 and a second connection portion 43 extended from a surface of the main body portion 41 facing the vibrator 22. The first connection portion 42 and the second connection portion 43 extend into the frame 1 to be fixed on the iron core 222, respectively.

Besides, the button motor 100 further includes two guide elements 9 wound on the first connection portion 42 and the second connection portion 43, respectively.

Furthermore, the button motor 100 includes an unmetallic elastic member 6 sandwiched between the iron core 222 and the frame 1. THE unmetallic elastic member 6 is configured to deform along the first direction Z.

The FPC 3 includes a first support segment 31 located on a side of the iron core 222 away from the button 4, and a bending segment 32 bended and extended from an end of the first support segment 31. Two ends of the first support segment 31 are fixed on a surface of the frame 1 away from the button 4. The first support segment 31 and the iron core 222 are arranged at an interval along the first direction Z. The bending segment 32 is fixed on an outer surface of the frame 1. The sensor 5 is mounted on the first support segment 31 and spaced apart from the iron core 222.

In one embodiment, the FPC 3 further includes a second support segment 34 sandwiched between the first support segment 31 and the button 4, and an elastic arm 33 connected with the second support segment 34 and the bending segment 32. The coil 221 is electrically connected with the second support segment 34. The elastic arm 33 is opposite to the unmetallic elastic member 6 along the first direction Z. In this manner, the FPC 3 deforms along with the vibrator 22, thereby detecting the press position and the pressure more precisely. An end of the second support segment 34 away from the elastic arm 33 is weld to the iron core 222 through two spaced welding pads 341.

A central region of the first support segment 31 is fixed on a side of iron core 222 away from the button 4 through a gasket 8. The sensor 5 is located on a side of the first support segment 31 towards the iron core 222 and spaced apart from the gasket 8. Thus, the FPC 3 is prone to fixed on the vibrator 22 and the frame 1. And, the first support segment 31 and the iron core 222 are arranged at an interval along the first direction Z.

In addition, the frame 1 includes two first side walls 13 opposite to each other along the second direction X, and two second walls 14 opposite to each other along a third direction Y. The third direction Y is perpendicular with the first direction Z and the second direction X. The two magnet units 211 are respectively fixed on the two first side walls 13. The bending segment 32 is fixed on one of the two second side walls 14. To be specific, the two mounting portions 11 are separately provided on the two second side walls 14 and extended along a direction away from the receiving space 10.

In one embodiment, the button motor 100 includes four sensors 5. The four sensors 5 are arranged on the first support segment 31 at intervals and spaced apart from the iron core 222.

The number of the unmetallic elastic member 6 is two. Two ends of the iron core 222 are mounted on the frame 1 through the two unmetallic elastic members 6, respectively.

The unmetallic elastic member 6 is made of silicone or rubber. Furthermore, the button motor 100 further includes a connection member 7 integrally-formed with the unmetallic elastic member 6. The unmetallic elastic member 6 is a blocky structure. In one embodiment, The unmetallic elastic member 6 is mounted on the iron core 222 through the connection member 7.

By providing the unmetallic elastic member 6 sandwiched between the iron core 222 and the frame 1 and configured to deform along the first direction Z, the receiving space 10 occupied by the elastic member is reduced, thereby increasing the size of the magnet to improve the driven force of the button motor 100.

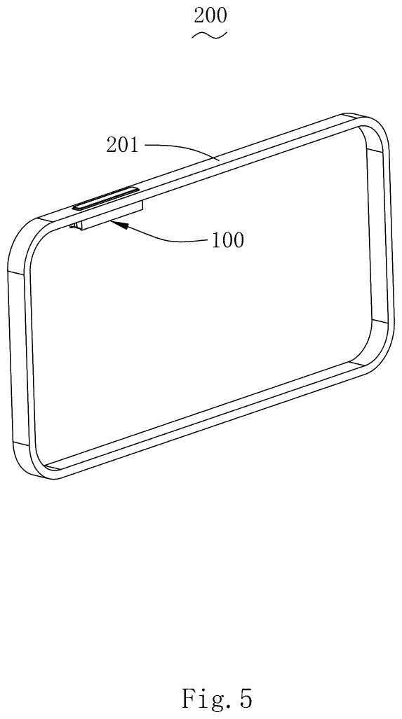

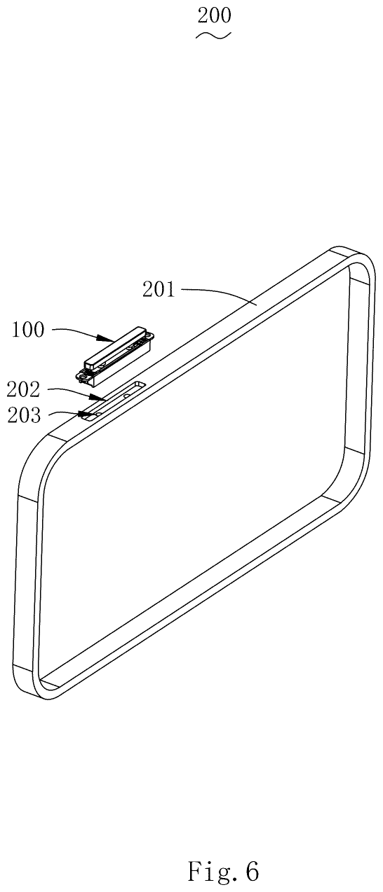

As shown in FIGS. 5-6, an electronic device 200 is provided. The electronic device 200 includes a cover 201 and the button motor 100 as described above. The button motor 100 is received in the cover 201. A receiving groove 202 is provided on the cover 201. Furthermore, a through hole 203 is provided by penetrating a bottom surface of the receiving groove 202. The frame 1 is mounted on an inner side of the cover 201. The button 4 of the button motor 100 is partially received in the receiving groove 202 and fixed on the vibrator 22 through the through hole 203.

Moreover, the button 4 is partially received in the receiving groove 202. The first connection portion 42 and the second connection portion 43 of the button 4 are fixed on the second support segment 34 of the FPC 3 by passing through the through hole 203 of the receiving groove 202.

When the guide element 9 is wound on the first connection portion 42 and the second connection portion 43, the guide element 9 is also received in the through hole 203.

The electronic device 200 would be devices that needs button control, such as mobile phone, XR device, AR device, earphone, or gamepads.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A button motor comprising:
a frame, having a receiving space;
a stator received in the receiving space, comprising a magnet unit mounted on the frame;
a vibrator moving along a first direction relative to the stator, comprising:
an iron core fixedly connected with the button; and
a coil wound on the iron core and arranged opposite to the magnet unit;
a button fixed on the vibrator;
a FPC mounted on the frame and electrically connected with the coil;
a sensor configured to detect the displacement of the vibrator; and
an unmetallic elastic member sandwiched between the iron core and the frame, configured to deform along the first direction.

2. The button motor as described in claim 1, wherein the unmetallic elastic member is made of silicone or rubber.

3. The button motor as described in claim 1, further comprising a connection member integrally-formed with the unmetallic elastic member; the unmetallic elastic member is a blocky structure; the unmetallic elastic member is mounted on the iron core through the connection member.

4. The button motor as described in claim 3, wherein a groove is provided on the unmetallic elastic member by depressing from a surface of the unmetallic elastic member facing the iron core away from the iron core; the connection member is formed inside the groove.

5. The button motor as described in claim 1, wherein the stator comprises two magnet units respectively arranged on both sides of the coil along a second direction perpendicular with the first direction; each of the two magnet units comprises three magnets arranged at intervals and fixed on the frame and magnetized along the second direction; adjacent two of the three magnets are magnetized along opposite direction.

6. The button motor as described in claim 5, wherein the FPC comprises a first support segment located on a side of the iron core away from the button, and a bending segment bended and extended from an end of the first support segment; two ends of the first support segment are fixed on the frame; the first support segment and the iron core are arranged at an interval along the first direction; the bending segment is fixed on the frame; the sensor is mounted on the first support segment and spaced apart from the iron core.

7. The button motor as described in claim 6, wherein the FPC further comprises a second support segment sandwiched between the iron core and the button, and an elastic arm connected with the second support segment and the bending segment; the coil is electrically connected with the second support segment; the elastic arm is opposite to the unmetallic elastic member along the first direction.

8. The button motor as described in claim 6, wherein a central region of the first support segment is fixed on a side of iron core away from the button through a gasket; the sensor is located on a side of the first support segment towards the iron core and spaced apart from the gasket.

9. The button motor as described in claim 6, wherein the frame comprises two first side walls opposite to each other along the second direction, and two second walls opposite to each other along a third direction; the third direction is perpendicular with the first direction and the second direction; the two magnet units are respectively fixed on the two first side walls; the bending segment is fixed on one of the two second side walls.

10. An electronic device, comprising a cover and the button motor as described in claim 1 received in the cover; wherein a receiving groove provided on the cover comprises a bottom surface and a through hole penetrating the bottom surface; the frame is mounted on an inner side of the cover; the button is partially received in the receiving groove and fixed on the vibrator through the through hole.
